(19) United States
(12) Patent Application Publication
(10) Pub. No.: US 2025/0297848 A1
(43) Pub. Date: Sep. 25, 2025

(54) Laser Interferometer And Spectroscopic Apparatus

(71) Applicant: SEIKO EPSON CORPORATION, Tokyo (JP)

(72) Inventors: Kohei YAMADA, Shiojiri (JP); Tetsuro MATSUMOTO, Chino (JP); Katsuhiko MAKI, Chino (JP)

(21) Appl. No.: 19/082,374

(22) Filed: Mar. 18, 2025

(30) Foreign Application Priority Data
Mar. 19, 2024 (JP) 2024-044027

(51) Int. Cl. G01B 9/02001; G01B 9/02; G01B 9/02002; G01J 3/45

(52) U.S. Cl. CPC G01B 9/0201; G01B 9/02002; G01B 9/02083; G01J 3/45; G01B 2290/70

(57) ABSTRACT

A laser interferometer includes a light modulator configured to add a modulation signal to a laser light by using a resonator, a photodetector configured to detect a change in intensity of the laser light including a sample signal and a modulation signal and output a laser light reception signal, a oscillator configured to generate a reference signal with a first frequency using the resonator as a vibratory source, and a demodulation circuit configured to demodulate the sample signal from the laser light reception signal based on the reference signal, wherein the demodulation circuit includes a DC offset remover, a first phase adjuster, a first multiplier, a first filter, a second multiplier, a second filter, and a phase calculator.

The present application is based on, and claims priority from JP Application Serial Number 2024-044027, filed Mar. 19, 2024, the disclosure of which is hereby incorporated by reference herein in its entirety.

### BACKGROUND

### 1. Technical Field

The present disclosure relates to a laser interferometer and a spectroscopic apparatus.

### 2. Related Art

JP-A-2020-165700 discloses a laser Doppler measurement apparatus which figures out a motion of a moving object. In the laser Doppler measurement apparatus, a measurement target is irradiated with a laser light, and a motion of the measurement target is measured based on Doppler-shifted scattered laser light. Specifically, a shift amount of a frequency of the laser light is obtained by the optical heterodyne interferometry, and velocity and a displacement of the moving object are obtained from the shift amount.

The laser Doppler measurement apparatus disclosed in JP-A-2020-165700 includes a frequency shifter type light modulator. Such a light modulator includes a quartz crystal AT resonator that performs thickness-shear vibration, and a diffraction grating having a plurality of grooves provided in parallel to a displacement direction of the resonator. The diffraction grating has a groove in a direction crossing a vibration direction of the quartz crystal AT resonator. When the diffraction grating is irradiated with the laser light, the laser light is diffracted and the frequency of the laser light is shifted.

JP-A-2020-165700 is an example of the related art.

However, thickness-shear vibration is high in resonance frequency. Therefore, a frequency of a modulation signal to be superimposed on the laser light by the light modulator disclosed in JP-A-2020-165700 is also high. Thus, in the laser Doppler measurement apparatus disclosed in JP-A-2020-165700, there arises a necessity of making a circuit that performs arithmetic processing on the modulation signal and a circuit that converts an analog signal into a digital signal cope with a high-frequency signal. As a result, an increase in cost of these circuits is incurred.

Therefore, there occurs a problem of realizing a laser interferometer that can reduce the frequency of a signal to be subjected to arithmetic processing in a demodulation circuit to achieve a reduction in cost of the demodulation circuit.

### SUMMARY

A laser interferometer according to an application example of the present disclosure is a laser interferometer configured to irradiate an object with a laser light and receive the laser light via the object to acquire a displacement of the object, the laser interferometer including
a laser source configured to emit the laser light,
a light modulator which includes a resonator and is configured to add a modulation signal to the laser light using the resonator,
a photodetector configured to detect a change in intensity of the laser light including a sample signal added by the object and the modulation signal to output a laser light reception signal,
a oscillator configured to generate a reference signal with a first frequency using the resonator as a vibratory source, and
a demodulation circuit configured to demodulate the sample signal from the laser light reception signal based on the reference signal to obtain the displacement of the object, wherein
the demodulation circuit includes
a DC offset remover configured to remove an offset of a direct current component of the laser light reception signal,
a first phase adjuster configured to adjust a phase of the reference signal,
a first multiplier configured to multiply the laser light reception signal output from the DC offset remover by the reference signal output from the first phase adjuster to output a first multiplication signal,
a first filter configured to remove a high-frequency component contained in the first multiplication signal,
a second multiplier configured to multiply the first multiplication signal and the reference signal output from the first phase adjuster to output a second multiplication signal,
a second filter configured to remove a high-frequency component contained in the second multiplication signal, and
a phase calculator configured to calculate a phase derived from the object as the sample signal based on a signal output from the first filter and a signal output from the second filter.

A spectroscopic apparatus according to an application example of the present disclosure includes
the laser interferometer according to the application example of the present disclosure, and
a spectroscopic analyzer which includes a spectroscopic optical system including a movable mirror and is configured to generate spectrum information derived from a sample, wherein
the laser interferometer measures a displacement of the movable mirror, and
the spectroscopic analyzer generates the spectrum information based on a measurement result of the displacement of the movable mirror by the laser interferometer.

### BRIEF DESCRIPTION OF THE DRAWINGS

FIG. 1 is a functional block diagram showing a laser interferometer according to a first embodiment.

FIG. 2 is a schematic configuration diagram showing an interference optical system in FIG. 1.

FIG. 3 is a perspective view showing configuration example of a light modulator shown in FIG. 2.

FIG. 4 is a perspective view showing another configuration example of the light modulator shown in FIG. 2.

FIG. 5 is a list showing coefficients contained in a DC term and terms representing harmonic components in a series representation of a laser light reception signal.

FIG. 6 is a graph showing an example of frequency characteristics of a phase delay amount of an AC component passing through a high-pass filter shown in FIG. 1.

FIG. 7 is a graph showing a result of simulating the influence of a phase delay amount difference ψ₁ on measurement accuracy of a displacement in a design example shown in FIG. 6.

FIG. 8 is a graph showing a result of simulating the influence of the phase delay amount difference ψ₁ on the accuracy of displacement in the design example shown in FIG. 6.

FIG. 9 is a graph created by calculating frequency characteristics (band characteristics) of gains and frequency characteristics (phase characteristics) of the phase delay amounts when the number of stages is changed to one, two, and three in a high-pass filter configured with an LCR circuit.

FIG. 10 is a functional block diagram showing a laser interferometer according to a third embodiment.

FIG. 11 is a functional block diagram showing a laser interferometer according to a fourth embodiment.

FIG. 12 is a functional block diagram showing a spectroscopic apparatus according to a fifth embodiment.

### DESCRIPTION OF EMBODIMENTS

A laser interferometer and a spectroscopic apparatus of the present disclosure will hereinafter be described in detail based on some embodiments shown in the accompanying drawings.

### 1. First Embodiment

First, a laser interferometer according to a first embodiment will be described.

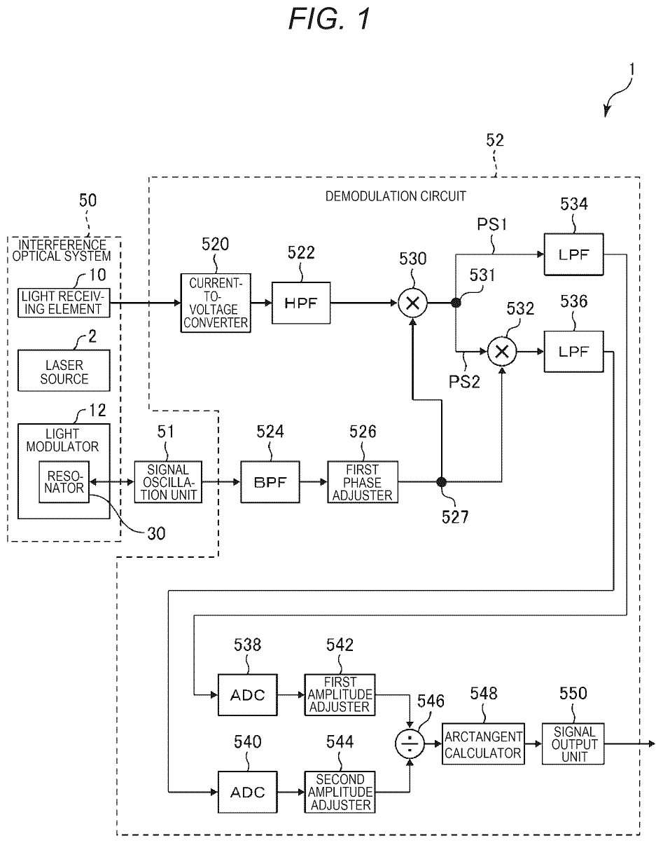

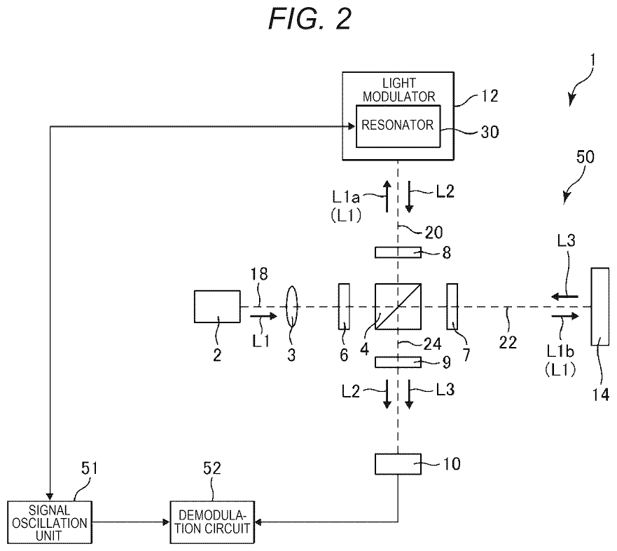

FIG. 1 is a functional block diagram showing a laser interferometer 1 according to the first embodiment. FIG. 2 is a schematic configuration diagram showing an interference optical system 50 in FIG. 1.

The laser interferometer 1 shown in FIG. 1 includes the interference optical system 50, a oscillator 51, and a demodulation circuit 52.

The interference optical system 50 shown in FIG. 2 splits a laser light emitted from a laser source 2 and causes the laser lights to be incident on an object 14 and a light modulator 12, respectively. Then, the laser lights returned from the object 14 and the light modulator 12, respectively, are received by a photodetector 10 in a mixed manner. The photodetector 10 detects a change in intensity of the laser light including a sample signal (phase information added to the laser light or the like) added by the object 14 and a modulation signal (frequency information added to the laser light or the like) added by the light modulator 12, and outputs a laser light reception signal.

The light modulator 12 illustrated in FIG. 1 includes a resonator 30. The light modulator 12 adds a modulation signal to the laser light using the resonator 30.

Further, the oscillator 51 illustrated in FIG. 1 generates a reference signal using the resonator 30 as a vibratory source.

The demodulation circuit 52 shown in FIG. 1 demodulates the sample signal from the laser light reception signal based on the reference signal. In this way, displacement or the like of the object 14 is acquired.

### 1.1. Interference Optical System

The interference optical system 50 shown in FIG. 2 is a Michelson interference optical system. As shown in FIG. 2, the interference optical system 50 includes the laser source 2, a collimating lens 3, a light splitter 4, a half-wave plate 6, a quarter-wave plate 7, a quarter-wave plate 8, an analyzer 9, and the photodetector 10.

The laser source 2 emits light L1 with a frequency f₀. The photodetector 10 converts an intensity of light received into an electrical signal. The light modulator 12 changes the frequency of the light L1 emitted using the resonator 30 to generate reference light L2 including the modulation signal (laser light including the modulation signal). Meanwhile, the light L1 emitted and incident on the object 14 is reflected as object light L3 including the sample signal (laser light including the sample signal) derived from the object 14.

A light path connecting the light splitter 4 and the laser source 2 is referred to as a light path 18. A light path connecting the light splitter 4 and the light modulator 12 is referred to as a light path 20. A light path connecting the light splitter 4 and the object 14 is referred to as a light path 22. A light path connecting the light splitter 4 and the photodetector 10 is referred to as a light path 24. Note that a “light path” in the present specification represents a path which is set between optical elements and on which light travels.

On the light path 18, the half-wave plate 6 and the collimating lens 3 are disposed in this order from the light splitter 4 side. The quarter-wave plate 8 is disposed on the light path 20. The quarter-wave plate 7 is disposed on the light path 22. The analyzer 9 is disposed on the light path 24.

The light L1 emitted from the laser source 2 passes through the light path 18 and is split into two beams by the light splitter 4. First split light L1a that is one of the beams into which the light L1 emitted is split passes through the light path 20 and is incident on the light modulator 12. Second split light L1b that is the other of the beams into which the light L1 emitted is split passes through the light path 22 and is incident on the object 14. The reference light L2 generated by the light modulator 12 shifting the frequency passes through the light path 20 and the light path 24 and enters the photodetector 10. The object light L3 generated by the reflection on the object 14 passes through the light path 22 and the light path 24 and is incident on the photodetector 10.

The laser interferometer 1 including such an interference optical system 50 as described above obtains phase information of the object 4 using the optical heterodyne interferometry. Specifically, two types of light (the reference light L2 and the object light L3) slightly different in frequency from each other are caused to interfere with each other. Then, the phase information is extracted in the demodulation circuit 52 from the intensity of the interfering light, and the displacement of the object 14 is obtained from the phase information. According to the optical heterodyne interferometry, extraction of the phase information from the interfering light is less susceptible to an influence of a disturbance, particularly to an influence of stray light with a frequency where the stray light becomes a noise, and thus high robustness is provided.

Hereinafter, each unit of the interference optical system 50 will further be described.

### 1.1.1. Laser Source

The laser source 2 is a laser source that emits the light L1 having coherency. As the laser source 2, a light source having a linewidth no higher than a MHz band is preferably used. Specifically, there can be cited a gas laser such as He—Ne laser, a semiconductor laser element such as a distributed feedback-laser diode (DFB-LD), a fiber Bragg grating laser diode (FBG-LD), a vertical cavity surface emitting laser (VCSEL), and a Fabry-Perot laser diode (FP-LD), and so on.

It is particularly preferable for the laser source 2 to be a semiconductor laser element. Thus, it becomes possible to particularly reduce the size of the laser source 2. Therefore, the reduction in size of the laser interferometer 1 can be achieved.

### 1.1.2. Collimating Lens

The collimating lens 3 is an optical element disposed between the laser source 2 and the light splitter 4, and an aspherical lens can be cited as an example thereof. The collimating lens 3 collimates the light L1 emitted from the laser source 2. Note that when the light L1 emitted from the laser source 2 is sufficiently collimated, for example, when gas laser such as He—Ne laser is used as the laser source 2, the collimating lens 3 may be omitted.

The light L1 emitted that becomes collimated light passes through the half-wave plate 6 to thereby be converted into linearly-polarized light the intensity ratio between P-polarized light and S-polarized light of which is, for example, 50:50, and is then incident on the light splitter 4.

### 1.1.3. Light Splitter

The light splitter 4 is a polarization beam splitter disposed between the laser source 2 and the light modulator 12 and between the laser source 2 and the object 14. The light splitter 4 has a function of transmitting P-polarized light and reflecting S-polarized light. Due to this function, the light splitter 4 splits the light L1 emitted into the first split light L1a that is light reflected by the light splitter 4 and the second split light L1b that is light transmitted by the light splitter 4.

The first split light L1a, which is S-polarized light reflected by the light splitter 4, is converted into circularly-polarized light by the quarter-wave plate 8, and enters the light modulator 12. The first split light L1a incident on the light modulator 12 is subjected to a frequency shift by f_{M} [Hz], and is reflected as the reference light L2. Therefore, the reference light L2 includes a modulation signal having a modulation frequency f_{M}. That is, a frequency of the reference light L2 is f₀+f_{M}. The reference light L2 is converted into P-polarized light when being transmitted through the quarter-wave plate 8 again. The P-polarized light of the reference light L2 is transmitted through the light splitter 4 and the analyzer 9 and is incident on the photodetector 10.

The second split light Lib that is the P-polarized light transmitted through the light splitter 4 is converted by the quarter-wave plate 7 into circularly-polarized light and is incident on the object 14 that is in motion. The second split light L1b incident on the object 14 is subjected to a Doppler shift at fa [Hz] and is reflected as the object light L3. Therefore, the object light L3 includes a sample signal having the Doppler frequency f_{D} [Hz]. That is, a frequency of the object light L3 is f₀-f_{D}. The object light L3 is converted into S-polarized light when being transmitted through the quarter-wave plate 7 again. The S-polarized light of the object light L3 is reflected by the light splitter 4, then transmitted through the analyzer 9, and is then incident on the photodetector 10.

Since the light L1 emitted has coherency, the reference light L2 and the object light L3 are incident on the photodetector 10 as interfering light.

### 1.1.4. Analyzer

Since S-polarized light and P-polarized light orthogonal to each other are independent of each other, beating due to interference does not appear by simply superimposing them on one another. Therefore, a light wave obtained by superimposing the S-polarized light and the P-polarized light on one another is made to pass through the analyzer 9 tilted by 45° with respect to both the S-polarized light and the P-polarized light. By using the analyzer 9, it is possible to transmit the light beams common in component to each other to thereby cause interference. As a result, in the analyzer 9, the reference light L2 and the object light L3 interfere with each other to generate the interfering light having a beating frequency of |f_{M}−f_{D}|.

### 1.1.5. Photodetector

When the interfering light is incident on the photodetector 10, the photodetector 10 outputs a photocurrent (a laser light reception signal) corresponding to an intensity of the interfering light. By demodulating the sample signal from the laser light reception signal using a method to be described later, the motion, that is, the displacement and the velocity, of the object 14 can finally be obtained. An example of the photodetector 10 includes a photodiode. The light received by the photodetector 10 is the laser light emitted from the laser source 2, but is not limited only to the interfering light described above as long as the modulation signal and the sample signal are superimposed on the laser light as a result that the frequency and the phase of the laser light are subjected to the modulation by the light modulator 12 and the object 14. Further, the phrase “demodulating the sample signal from the laser light reception signal” in the present specification refers to extracting the sample signal by performing a variety of operations on the laser light reception signal.

### 1.2. Light Modulator

The light modulator 12 illustrated in FIG. 1 includes the resonator 30. In the light modulator 12, as shown in FIG. 2, the frequency of the first split light L1a is modulated using the resonator 30. According to such a configuration, it is possible to achieve a reduction of the size, weight, and power consumption of the light modulator 12. Further, the oscillation of the resonator 30 is a vibratory source when the oscillator 51 generates the reference signal. Therefore, origins of a modulation signal added to the reference light L2 by the resonator 30 and the reference signal output from the oscillator 51 with the resonator 30 as the vibratory source are both the vibrational energy of the resonator 30. Therefore, even when a disturbance such as an impact or a noise is applied to the light modulator 12 and the vibration of the resonator 30 changes, it results in that both the modulation signal and the reference signal change similarly. Then, it is possible to cancel out or reduce the influences of both the disturbances in the process of the arithmetic processing in the demodulation circuit 52. As a result, a decrease in a signal-to-noise ratio (S/N ratio) of the sample signal demodulated by the demodulation circuit 52 can be suppressed.

The resonator 30 is a resonator that generates a periodic signal, such as a quartz crystal resonator, a ceramic resonator, or an Si resonator. Such a resonator is a resonator using a mechanical resonance phenomenon, and is therefore high in Q value, and excellent in vibration frequency stability.

Examples of a quartz crystal resonator include a quartz crystal AT resonator, an SC-cut quartz crystal resonator, a tuning fork type quartz crystal resonator, and a quartz crystal surface acoustic wave element. An oscillation frequency of the quartz crystal resonator is, for example, from approximately 1 kHz to several hundreds of MHZ.

The silicon resonator is a resonator including a single crystal silicon element manufactured from a single crystal silicon substrate using the MEMS technology, and a piezoelectric film. The term MEMS (micro electro-mechanical systems) means micro electromechanical systems. Examples of the shape of the single crystal silicon element include a cantilever shape such as a two-leg tuning fork shape or a three-leg tuning fork shape, and a fixed-fixed beam shape. An oscillation frequency of the silicon resonator is, for example, from approximately 1 kHz to several hundreds of MHZ.

The ceramic resonator is a resonator including a piezoelectric ceramic element manufactured by sintering piezoelectric ceramics, and electrodes. Examples of the piezoelectric ceramics include lead zirconate titanate (PZT) and barium titanate (BTO). An oscillation frequency of the ceramic resonator is, for example, from approximately several hundreds of kHz to several tens of MHZ.

Among these, the quartz crystal resonator is preferably used as the resonator 30. The quartz crystal resonator has particularly high frequency stability since the quartz crystal itself is the piezoelectric material.

The oscillation frequency of the resonator 30 is not particularly limited, but is preferably no lower than 1 MHz and no higher than 100 MHZ. In a frequency band within the range described above, most of the resonators are high in Q value of the mechanical resonance. Therefore, by setting the oscillation frequency within the range described above, stabilization of the first frequency f_{M} of the reference signal I_{S1} output from the oscillator 51 can be achieved.

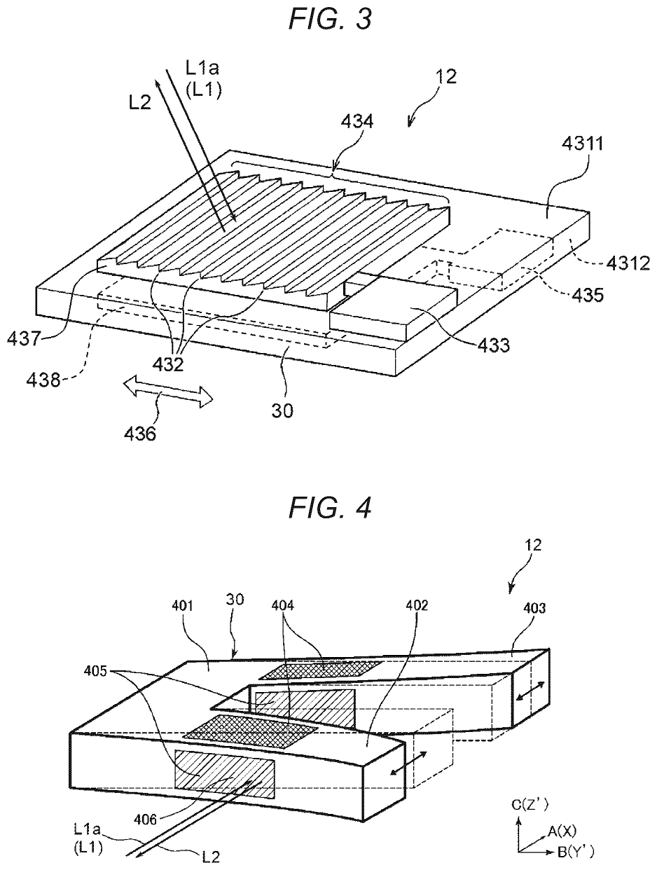

FIG. 3 is a perspective view showing a configuration example of the light modulator 12 shown in FIG. 2.

Examples of the light modulator 12 shown in FIG. 3 include a light modulator disclosed in JP-A-2022-38156. Specifically, the light modulator 12 shown in FIG. 3 includes the resonator 30 and a diffraction grating 434 which is provided to the resonator 30 to diffract the first split light L1a (the laser light thus split).

The resonator 30 shown in FIG. 3 is a quartz crystal AT resonator that makes thickness-shear vibration along a vibration direction 436 in a high-frequency region in a MHz band. Further, the diffraction grating 434 is provided to the resonator 30. The diffraction grating 434 includes a plurality of grooves 432 shaped like straight lines extending in a direction crossing the vibration direction 436. When such a diffraction grating 434 is irradiated with the first split light L1a, the frequency of the first split light L1a can be modulated to generate the reference light L2 even when the resonator 30 makes the thickness-shear vibration.

The resonator 30 has an obverse surface 4311 and a reverse surface 4312, which are in an obverse-reverse relationship with each other. The diffraction grating 434 is disposed at the obverse surface 4311. Further, a first electrode 437 for applying a voltage to the resonator 30 and a pad 433 electrically coupled to the first electrode 437 are disposed on the obverse surface 4311. Meanwhile, a second electrode 438 for applying a voltage to the resonator 30 and a pad 435 electrically coupled to the second electrode 438 are disposed at the reverse surface 4312. The first electrode 437 and the second electrode 438 overlap each other via the resonator 30 when in a plan view of the obverse surface 4311. Further, the pads 433, 435 do not overlap each other via the resonator 30. When a voltage is applied between the first electrode 437 and the second electrode 438, a thickness-shear vibration is induced in a portion where the first electrode 437 and the second electrode 438 overlap each other.

The diffraction grating 434 shown in FIG. 3 is disposed at the first electrode 437. That is, in FIG. 3, the diffraction grating 434 is configured with the plurality of grooves 432 formed on a surface of the first electrode 437, and when the diffraction grating 434 is irradiated with the first split light L1a, the reference light L2 as diffracted light is emitted.

The diffraction grating 434 shown in FIG. 3 is, for example, a blazed diffraction grating. The blazed diffraction grating refers to a diffraction grating the cross-sectional shape of which has a stepped shape. Note that the shape of the diffraction grating 434 is not limited thereto.

FIG. 4 is a perspective view showing another configuration example of the light modulator 12 shown in FIG. 2. Note that in FIG. 4, an A axis, a B axis, and a C axis are set as three axes orthogonal to each other, and are represented by arrows. A tip side of the arrow is defined as a “positive side”, and a base end side of the arrow is defined as a “negative side”.

The resonator 30 shown in FIG. 4 is a tuning fork type quartz crystal resonator. The resonator 30 shown in FIG. 4 includes a vibrating substrate including a base portion 401, a first vibrating arm 402, and a second vibrating arm 403. Such a tuning fork type quartz crystal resonator is easily available since the manufacturing technique thereof has been established, and is stable in oscillation. Therefore, the tuning fork type quartz crystal resonator is suitable as the resonator 30. Further, the light modulator 12 illustrated in FIG. 4 includes the resonator 30, and electrodes 404, 405 and a light reflection portion 406 provided to the resonator 30.

The base portion 401 is a region extending along the A axis. The first vibrating arm 402 is a region of the base portion 401 extending from an end portion at the negative side of the A axis toward the positive side of the B axis. The second vibrating arm 403 is a region of the base portion 401 extending from an end portion at the positive side of the A axis toward the positive side of the B axis.

The electrodes 404 are electrically-conductive films disposed at side surfaces parallel to an A-B plane of the first vibrating arm 402 and the second vibrating arm 403. Note that although not shown in FIG. 4, the electrodes 404 are respectively disposed at side surfaces opposed to each other, and drive the first vibrating arm 402 and the second vibrating arm 403 by voltages different in polarity being applied to the electrodes 404.

The electrodes 405 are electrically-conductive films disposed at side surfaces crossing the A-B plane of the first vibrating arm 402 and the second vibrating arm 403. Note that although not shown in FIG. 4, the electrodes 405 are also disposed at side surfaces opposed to each other, respectively, and drive the first vibrating arm 402 and the second vibrating arm 403 by voltages different in polarity being applied to the electrodes 405.

The light reflection portion 406 is set at a side surface crossing, for example, the A-B plane of the first vibrating arm 402 and the second vibrating arm 403, and has a function of reflecting the first split light L1a. Due to this function, since the light reflection portion 406 has a vibration component large in amplitude in the incident direction of the first split light L1a incident thereon, it is possible to efficiently modulate the frequency of the first split light L1a to generate the reference light L2.

As the tuning fork type quartz crystal resonator, a quartz crystal element carved out from a quartz crystal substrate is used. Examples of the quartz crystal substrate used to manufacture the tuning fork type quartz crystal resonator include a quartz crystal Z-cut flat plate. An X axis parallel to the A axis, a Y′ axis parallel to the B axis, and a Z′ axis parallel to the C axis are set in FIG. 4. The quartz crystal Z-cut flat plate is, for example, a substrate carved out from a single crystal of quartz crystal such that the X axis is an electrical axis, the Y′ axis is a mechanical axis, and the Z′ axis is an optical axis. Specifically, in an orthogonal coordinate system configured with the X axis, the Y′ axis, and the Z′ axis, a substrate having a principal surface obtained by inclining an X-Y′ plane including the X axis and the Y′ axis by about 1° to 5° in a counterclockwise direction around the X axis is carved out from the single crystal of quartz crystal and is preferably used as the quartz crystal substrate. Further, by etching such a quartz crystal substrate, a quartz crystal element used in the resonator 30 shown in FIG. 4 is obtained.

### 1.3. Oscillator

The oscillator 51 illustrated in FIG. 1 generates the reference signal I_{S1} having the first frequency f_{M} using the resonator 30 as a vibratory source.

Examples of the oscillator 51 include an oscillation circuit using an inverter and a Colpitts oscillation circuit. These oscillation circuits operate using fundamental mode oscillation of the resonator 30 as a vibratory source. Therefore, by using the resonator 30 high in Q value of mechanical resonance, the reference signal I_{S1} high in frequency stability can be generated.

Note that the light modulator 12 and the oscillator 51 may be housed in one package. Thus, since the physical distance between both components becomes short, the influence of noise or the like is suppressed.

### 1.4. Demodulation Circuit

First, a configuration of the demodulation circuit 52 will be described.

### 1.4.1. Configuration of Demodulation Circuit

The demodulation circuit 52 illustrated in FIG. 1 includes a current-to-voltage converter 520, a high-pass filter 522 (a DC offset remover), a band-pass filter 524 (a third filter), a first phase adjuster 526, a first multiplier 530, a second multiplier 532, a low-pass filter 534 (a first filter), a low-pass filter 536 (a second filter), an A/D converter 538, an A/D converter 540, a first amplitude adjuster 542, a second amplitude adjuster 544 (an amplifier), a divider 546, an arctangent calculator 548 (a phase calculator), and a signal output unit 550.

The current-to-voltage converter 520 is also called a transimpedance amplifier (TIA), which converts the photocurrent output from the photodetector 10 into a voltage signal and outputs the voltage signal as the laser light reception signal.

The high-pass filter 522 removes the offset (DC offset) of the DC component of the laser light reception signal. Thus, the laser light reception signal configured with AC components is obtained.

The band-pass filter 524 passes only the component with the first frequency f_{M} with respect to the reference signal output from the oscillator 51. Thus, the reference signal from which unnecessary frequency components (noise components) are removed is obtained. When the unnecessary frequency components are small in the reference signal output from the oscillator 51, the band-pass filter 524 may be omitted.

The first phase adjuster 526 adjusts the phase of the reference signal output from the band-pass filter 524. Specifically, the first phase adjuster 526 adjusts the phase of the reference signal so as to be in phase with the phase of the fundamental frequency component of the modulation signal contained in the laser light reception signal. The reference signal output from the first phase adjuster 526 is divided into two at a branch point 527.

The first multiplier 530 multiplies the laser light reception signal output from the high-pass filter 522 by the reference signal output from the first phase adjuster 526. In this way, a first multiplication signal is obtained. The first multiplication signal is divided into a first calculation path PS1 and a second calculation path PS2 at a branch point 531.

The second multiplier 532 multiplies the first multiplication signal divided to the second calculation path PS2 by the reference signal output from the first phase adjuster 526. In this way, the second multiplication signal is obtained.

The low-pass filter 534 cuts the high-frequency component with respect to the first multiplication signal divided to the first calculation path PS1. Thus, the first multiplication signal including a low frequency component is obtained. Note that the low-pass filter 534 may be a band-pass filter.

The low-pass filter 536 cuts the high-frequency component with respect to the second multiplication signal output from the second multiplier 532. Thus, the second multiplication signal including a low frequency component is obtained. Note that the low-pass filter 536 may be a band-pass filter.

Note that the high-pass filter 522 (a DC offset remover), the band-pass filter 524, the first phase adjuster 526, the first multiplier 530, the second multiplier 532, the low-pass filter 534, and the low-pass filter 536 are constituents of an analog circuit.

The A/D converter 538 converts the first multiplication signal as an analog signal output from the low-pass filter 534 into a digital signal. Thus, the first multiplication signal as a digital signal is obtained.

The A/D converter 540 converts the second multiplication signal as an analog signal output from the low-pass filter 536 into a digital signal. Thus, the second multiplication signal as a digital signal is obtained.

The first amplitude adjuster 542 and the second amplitude adjuster 544 adjust the amplitude of the first multiplication signal and the amplitude of the second multiplication signal so that the amplitudes of the signals input thereto are uniformed. This can enhance the demodulation accuracy of the phase X. Note that these are sufficiently provided as needed, and may be omitted when, for example, a difference in amplitude between the signals input thereto is small. Further, when the adjustment can be achieved by only either one of the first amplitude adjuster 542 and the second amplitude adjuster 544, the other may be omitted.

The divider 546 divides the first multiplication signal output from the first amplitude adjuster 542 by the second multiplication signal output from the second amplitude adjuster 544. Thus, a division signal is obtained.

The calculator arctangent 548 performs arctangent calculation on the division signal output from the divider 546. In this way, the phase as the sample information derived from the object 14 is calculated.

The signal output unit 550 phase connection such as unwrapping processing on the phase derived from the object 14. Further, the displacement and the speed of the object 14 are calculated as needed.

Note that the first amplitude adjuster 542, the second amplitude adjuster 544, the divider 546, the arctangent calculator 548, and the signal output unit 550 may configure an analog circuit, but are preferably constituents of a digital circuit. Such a digital circuit is installed in an electronic device such as a programmable logic device (FPGA), an application specific integrated circuit (ASIC), or a microcomputer.

### 1.4.2. Demodulation Processing

Then, an operation of the demodulation circuit 52 (demodulation processing) will be described. Note that in the following description, as an example, there is described when a signal the frequency of which changes in a sinusoidal manner is used as the modulation signal and the displacement of the object 14 makes a simple harmonic oscillation in an optical axis direction.

The laser light reception signal output from the current-to-voltage converter 520 is input to the high-pass filter 522. The high-pass filter 522 removes the DC offset of the laser light reception signal. Thus, the laser light reception signal configured with AC components is obtained. The AC component is represented by I_{PD.AC}. Note that in the following description, the AC component I_{PD.AC} is referred to as a laser light reception signal I_{PD.AC} output from the high-pass filter 522. The laser light reception signal I_{PD.AC} output from the high-pass filter 522 is expressed by Formula (1) described below.

$${I}_{PD . AC} = A cos ( {Φ}_{M} - X ) \qquad ( 1 )$$

In Formula (1) described above, A is an amplitude. Further, Φ_{M} is a phase derived from the light modulator 12. Further, X is a phase given by Formula (1a) described below.

$$X = {Φ}_{S} - {Φ}_{0} \qquad ( 1 a )$$

In Formula (1a) described above, Φ_{S} is a phase derived from the object 14, and Φ₀ is an initial phase difference due to a light path difference in the interference optical system 50.

The light modulator 12 illustrated in FIG. 2 generates the reference light L2 including the modulation signal having the modulation frequency f_{M}. Therefore, Φ_{M} is given by Formula (1b) described below.

$${Φ}_{M} = B sin 2 π {f}_{M} t \qquad ( 1 b )$$

In formula (1b) described above, B is a modulation phase shift in frequency modulation by the light modulator 12. Further, t denotes time.

When using Formula (1b) described above, Formula (1) described above is expressed by Formula (1c) described below.

$$\begin{matrix}\text{?} = A cos ( B sin {ω}_{M} t - X ) \\ = A [ cos ( B sin {ω}_{M} t ) cos X - sin ( B sin {ω}_{M} t ) sin X ]\end{matrix} \qquad ( 1 c )$$

$$\text{?} \text{indicates text missing or illegible when filed}$$

The right-hand side of Formula (1c) described above is a formula including a trigonometric function including a trigonometric function in which the angle portion changes with time in the angle portion. In this case, when the series representation of the Bessel function is used, the right-hand side of Formula (1c) described above can be expanded as in Formula (1d) described below.

$${I}_{PD , AC} = A [ \{ {J}_{0} ( B ) + 2 {J}_{2} ( B ) cos 2 {ω}_{M} t + 2 {J}_{4} ( B ) cos 4 {ω}_{M} t + ⋯ \} cos X - \{ 2 {J}_{1} ( B ) sin {ω}_{M} t + 2 {J}_{3} ( B ) sin 3 {ω}_{M} t + ⋯ \} sin X ] \qquad ( 1 d )$$

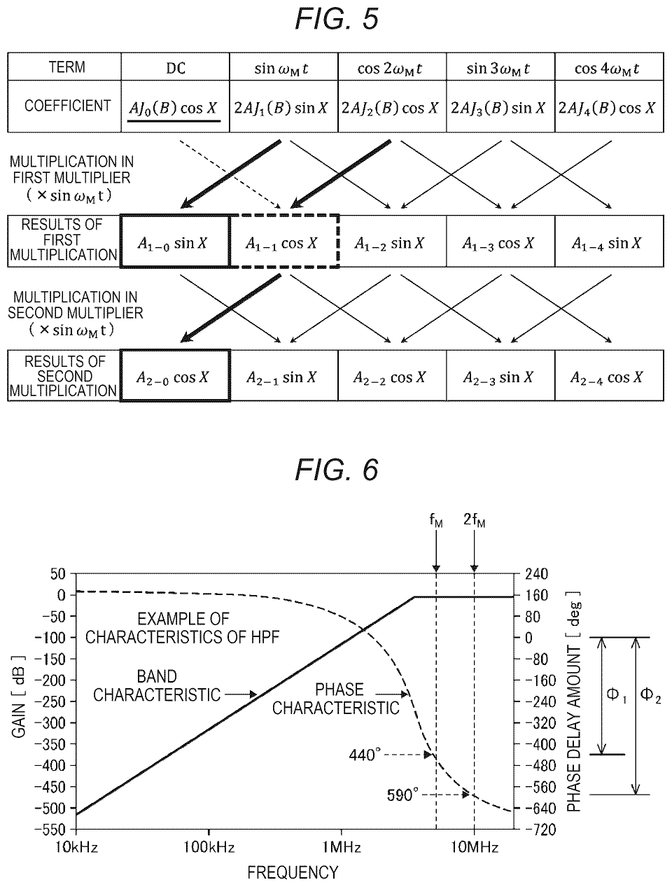

Formula (1d) described above is divided into a term (DC term) excluding a modulation angular frequency ω_{M}, and a term representing a harmonic component such as a term (sin(ω_{M}t) term) including sin(ω_{M}t) or a term (cos(2ω_{M}t) term) including cos(2ω_{M}t). FIG. 5 shows a list coordinating these terms and coefficients contained in each of the terms.

FIG. 5 is a list showing coefficients contained in the DC term and the terms representing the harmonic components in the series representation of the laser light reception signal.

As illustrated in FIG. 5, the coefficients of each of the terms include cos(X) or sin(X). In the demodulation circuit 52, the phase Φ_{S} derived from the object 14 is finally calculated by extracting these by calculation. In particular, in the present embodiment, sin(X) contained in the coefficient of sin(ω_{M}t) term and cos(X) contained in the coefficient of cos(2ω_{M}t) term are extracted to finally obtain the phase X.

Here, the reference signal I_{S1} output from the first phase adjuster 526 is expressed by Formula (2) described below.

$${I}_{S 1} = {V}_{q} sin {ω}_{M} t \qquad ( 2 )$$

In Formula (2) described above, V_{q} denotes an amplitude. Further, ω_{M} is the angular frequency (modulation angular frequency) of the modulation frequency f_{M}, and is 2πf_{M}.

The first multiplier 530 multiplies the laser light reception signal I_{PD.AC} output from the high-pass filter 522 by the reference signal I_{S1} output from the first phase adjuster 526. This multiplication (first multiplication) is an operation of multiplying Formula (1d) by Formula (2). In this way, a first multiplication signal is obtained. The first multiplication signal is divided at the branch point 531 shown in FIG. 1. The high-frequency component of the first multiplication signal divided to the first calculation path PS1 is cut by the low-pass filter 534. The cut-off angular frequency of the low-pass filter 534 is set to, for example, ω_{M}/2. Thus, the first multiplication signal output from the low-pass filter 534 becomes a signal configured with the component of the DC term illustrated in FIG. 5. This component includes sin(X) and does not include the modulation angler frequency ω_{M}. Therefore, due to the processing described above, the first multiplication signal is made lower in frequency.

The concept of the first multiplication is shown in FIG. 5. In FIG. 5, the process that sin(X) and cos(X) contained in the coefficients make the transition due to the first multiplication and the second multiplication described later is conceptually illustrated using arrows. When the first multiplication is performed, sin(X) contained in the coefficient of sin(ω_{M}t) term makes the transition to the coefficient of the DC term and the coefficient of cos(2ω_{M}t) term, respectively. Further, cos(X) contained in the coefficient of cos(2ω_{M}t) term makes the transition to the coefficient of sin(ω_{M}t) term and the coefficient of sin(3ω_{M}t) term, respectively. Similarly, in other terms, sin(X) or cos(X) makes the transition from the base end to the tip of the arrow.

Then, when the removal of the harmonic components in the low-pass filter 534 is performed, only the DC term is output. That is, in the result of the first multiplication shown in FIG. 5, the component of the DC term including the coefficient surrounded by the thick frame of the solid line is output from the low-pass filter 534. The first multiplication signal Iₕₑₜ₁ output from the low-pass filter 534 is expressed by Formula (3) described below.

$${I}_{het 1} = {AJ}_{1} ( B ) {V}_{q} sin X \qquad ( 3 )$$

The second multiplier 532 multiplies the first multiplication signal Iₕₑₜ₁ divided to the second calculation path PS2 by the reference signal I_{S1} output from the first phase adjuster 526. This multiplication (second multiplication) is an operation of multiplying the first multiplication signal by Formula (2) described above. In this way, the second multiplication signal is obtained. The high-frequency component of the second multiplication signal is cut by the low-pass filter 536. The cut-off angular frequency of the low-pass filter 536 is set to, for example, ω_{M}/2. Thus, the second multiplication signal output from the low-pass filter 536 becomes a signal configured with the component of the DC term shown in FIG. 5. This component includes cos(X) but does not include the modulation angler frequency ω_{M}. Therefore, due to the processing described above, the second multiplication signal is made lower in frequency.

The concept of the second multiplication is shown in FIG. 5. When the second multiplication is performed, the cos(X) contained in the coefficient of sin(ω_{M}t) term (the coefficient surrounded by the thick frame of the broken line) in the result of the first multiplication makes the transition to the coefficient of the DC term and the coefficient of cos(2ω_{M}t) term. Similarly, in other terms, sin(X) or cos(X) makes the transition from the base end to the tip of the arrow.

Then, when the removal of the harmonic components in the low-pass filter 536 is performed, only the DC term is output. That is, in the result of the second multiplication shown in FIG. 5, the component of the DC term including the coefficient surrounded by the thick frame of the solid line is output from the low-pass filter 536. The second multiplication signal Iₕₑₜ₂ output from the low-pass filter 536 is expressed by Formula (4) described below.

$${I}_{het 2} = \frac{A}{2} {J}_{2} ( B ) {V}_{q}^{2} cos X \qquad ( 4 )$$

In this way, the reduction in frequency of the first multiplication signal and the second multiplication signal can be achieved, and it is possible to output the first multiplication signal Tₕₑₜ₁ configured with the component including sin(X) and the second multiplication signal Iₕₑₜ₂ configured with the component including cos(X) toward the A/D converter 538 and the A/D converter 540.

Note that among the results of the first multiplication illustrated in FIG. 5, the transition of cos(X) represented by the broken line arrow and the transition of cos(X) represented by the thick solid line arrow are superimposed in the coefficient surrounded by the thick frame of the broken line. In this case, cos(X) after the transition represented by the broken line arrow needs to be removed since it can become a noise component for the cos(X) after the transition represented by the solid line arrow.

Therefore, in the present embodiment, the high-pass filter 522 described above is provided to the demodulation circuit 52. As described above, the high-pass filter 522 removes the DC offset of the laser light reception signal. By removing the DC offset, the coefficients (coefficients of the DC term) underlined in FIG. 5 are removed. Therefore, it is possible to stop the transition of the cos(X) represented by the broken line arrow. As a result, superimposition of noise components can be prevented.

The first multiplication signal Iₕₑₜ₁ converted by the A/D converter 538 into the digital signal is input to the first amplitude adjuster 542. The second multiplication signal Iₕₑₜ₂ converted by the A/D converter 540 into the digital signal is input to the second amplitude adjuster 544. The first amplitude adjuster 542 and the second amplitude adjuster 544 adjust the amplitudes of the signals input thereto so as to be uniformed. Specifically, the first amplitude adjuster 542 multiplies the signal input thereto by J₂(b)V_{q}, and the second amplitude adjuster 544 multiplies the signal input thereto by 2J₁(b). Thus, the first multiplication signal Tₕₑₜ₁ output from the first amplitude adjuster 542 and the second multiplication signal Iₕₑₜ₂ output from the second amplitude adjuster 544 are given by Formulas (5), (6) described below, respectively.

$${I}_{het 1} = A {J}_{1} ( B ) {J}_{2} ( B ) {V}_{q}^{2} sin X \qquad ( 5 )$$

$${I}_{het 2} = A {J}_{1} ( B ) {J}_{2} ( B ) {V}_{q}^{2} cos X \qquad ( 6 )$$

The divider 546 divides the first multiplication signal Iₕₑₜ₁ output from the first amplitude adjuster 542 by the second multiplication signal Iₕₑₜ₂ output from the second amplitude adjuster 544. Thus, a division signal is obtained.

The arctangent calculator 548 performs arctangent calculation on the division signal output from the divider 546. The arctangent calculation result Iₐₜₐₙ is expressed by Formula (7) described below.

$${I}_{atan} = atan ( \frac{sin X}{cos X} ) \qquad ( 7 )$$

The phase X is obtained from the arctangent calculation result Iₐₜₐₙ expressed by Formula (7) described above.

In the demodulation processing described above, the frequencies of the first multiplication signal Iₕₑₜ₁ and the second multiplication signal Iₕₑₜ₂ input to the A/D converters 538, 540 are suppressed to values lower than the modulation frequency f_{M}. That is, the frequencies are down-converted. Accordingly, a coping frequency of the A/D converters 538, 540 can be lowered, and the reduction in cost of the A/D converters 538, 540 can be achieved.

Further, the digital circuit described above is implemented in, for example, an FPGA, and by performing the down-conversion described above, it is possible to lower the coping frequency of the FPGA or the like. Therefore, the down-conversion described above can also contribute to the cost reduction of an electronic component such as an FPGA.

Further, the restriction can be removed with respect to the modulation frequency f_{M} by the light modulator 12 in which the coping frequency described above acts as a rate-limiting factor. For example, it becomes easy to use a resonator, which has a very high modulation frequency f_{M}, for example, a resonator which has an oscillation frequency in the MHz band, and which has been difficult to adopt in the related art in terms of the coping frequency described above, in the light modulator 12. Thus, it is possible to open up the option of the resonator which can be adopted.

Further, in the analog circuit described above, the number of multipliers is suppressed to as small as two. Therefore, mixture of the noise due to the multiplication is suppressed, and it becomes possible to highly accurately calculate the phase X.

### 2. Second Embodiment

Then, a laser interferometer according to a second embodiment will be described.

Although the second embodiment will hereinafter be described, in the following description, the description will be presented with a focus on differences from the embodiment described above, and description of substantially the same issues will be omitted.

The second embodiment is substantially the same as the first embodiment except that the configuration of the high-pass filter 522 is different.

In the high-pass filter 522, the DC offset of the laser light reception signal is removed and the AC component is transmitted. However, depending on the frequency characteristics of the phase delay amount of the AC component transmitted through the high-pass filter 522, the difference in the phase delay amount between the sin(ω_{M}t) term and the cos(2ω_{M}t) term becomes large, which may deteriorate the demodulation accuracy and the accuracy of the phase X.

FIG. 6 is a graph illustrating an example of the frequency characteristics of the phase delay amount of the AC component passing through the high-pass filter 522 illustrated in FIG. 1. The horizontal axis represents the frequency. The left vertical axis represents the gain. The right vertical axis represents the phase delay amount with reference to when the gain is zero. The pass band shown in FIG. 6 is a band which is designed in accordance with the frequency of the AC component intended to pass through the high-pass filter 522. In the example shown in FIG. 6, the modulation frequency f_{M} is assumed to be 5 MHZ, a lower limit is set to 5 MHz, and the pass band is set so as to have an upper limit of 10 MHz that is twice as high as the lower limit. By suppressing the difference in the phase delay amount within the pass band to be small, it is possible to suppress the decrease in the demodulation accuracy and the accuracy of the phase X.

Here, the reason why the difference in the phase delay amount within the pass band affects the demodulation accuracy of the phase X is considered.

In FIG. 6, the phase delay amount when a component with 5 MHz passes is represented by Φ₁, and the phase delay amount when a component with 10 MHz twice as high as 5 MHz passes is represented by Φ₂. In that case, the phase delay amount difference ψ₁ within the pass band is given as |Φ₁−Φ₂|. The phase delay amount difference ψ₁ has an influence expressed by Formula (8) described below on the arctangent calculation result Iₐₜₐₙ in the demodulation processing.

$${I}_{atan} = {tan}^{- 1} ( \frac{sin X}{cos X cos {ψ}_{1}} ) \qquad ( 8 )$$

Since the right-hand side of Formula (8) described above includes cos(ψ₁) and is different from the right-hand side of Formula (7) described above, it is understood that this difference is an error factor degrading the demodulation accuracy of the phase X.

In the present embodiment, the high-pass filter 522 is set so as to satisfy Formula (9) described below with respect to the phase delay amount difference ψ₁.

$${ψ}_{1} ≦ 10 [ deg ] \qquad ( 9 )$$

Further, preferably, the high-pass filter 522 is set so as to satisfy Formula (10) described below.

$${ψ}_{1} ≦ 1 [ deg ] \qquad ( 10 )$$

According to such a configuration, the demodulation accuracy and the accuracy of the phase X can be improved. As a result, the measurement accuracy of the displacement of the object 14 and the accuracy of the displacement measured can be improved.

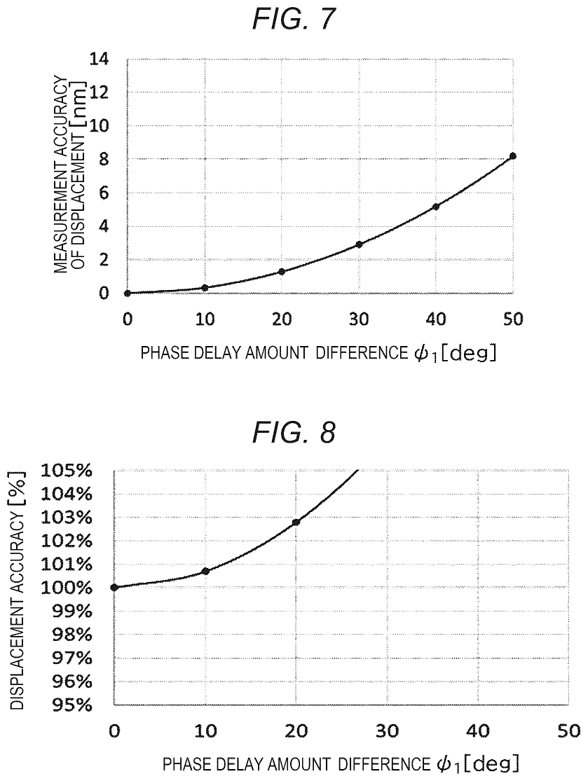

FIG. 7 is a graph showing a result of simulating the influence of the phase delay amount difference ψ₁ on the measurement accuracy of the displacement in the design example shown in FIG. 6.

As shown in FIG. 7, when the phase delay amount difference ψ₁ is 10 [deg] or less, the measurement accuracy of the displacement is suppressed to 1 nm or less. Therefore, by setting the phase delay amount difference ψ₁ within the range described above, sufficient measurement accuracy can be obtained.

FIG. 8 is a graph showing a result of simulating the influence of the phase delay amount difference ψ₁ on the accuracy of the displacement in the design example shown in FIG. 6.

As shown in FIG. 8, when the phase delay amount difference ψ₁ is 1 [deg] or less, the accuracy of the displacement measured is suppressed within 100±0.01%. Therefore, by setting the phase delay amount difference ψ₁ within the range described above, sufficient measurement accuracy can be obtained.

As described above, examples of the method of suppressing the phase delay amount difference ψ₁ within the predetermined range include a change in the constants of the elements of the LCR circuit, an increase in the number of stages, and a decrease in the cut-off frequency in the design of the high-pass filter 522.

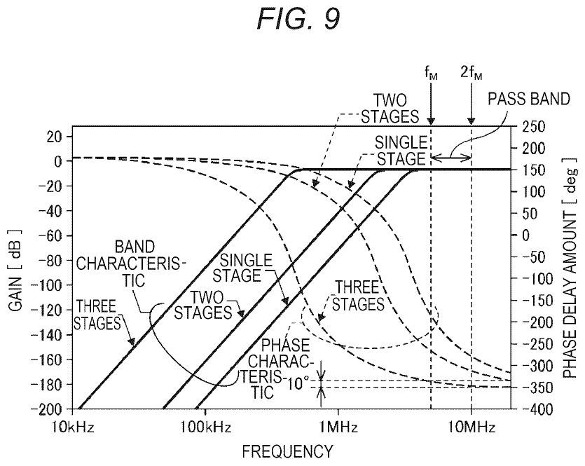

FIG. 9 is a graph created by calculating the frequency characteristic (a band characteristic) of the gain and the frequency characteristic (a phase characteristic) of the phase delay amount when the number of stages is changed to single stage, two stages, and three stages in a high-pass filter configured with an LCR circuit. When the number of stages is changed, the cut-off frequency of the band characteristic is shifted, and the phase characteristic is also shifted.

In the design example shown in FIG. 9, when the number of stages of the LCR circuit is set to three, the phase delay amount difference ψ₁ is suppressed to 10 [deg] or less. In this way, by adjusting the design of the LCR circuit, the phase delay amount difference ψ₁ can be suppressed to 10 [deg] or less, or 1 [deg] or less.

In such a second embodiment as described above, substantially the same advantages as those of the first embodiment can be obtained.

### 3. Modified Example of Second Embodiment

Then, a laser interferometer 1 according to a modified example of the second embodiment will be described.

The modified example of the second embodiment will hereinafter be described, and in the following description, differences from the second embodiment will be focused on, and description of substantially the same matters will be omitted.

In the modified example of the second embodiment, a calculation of dividing a signal to be input to the second amplitude adjuster 544 by cos(ψ₁) is added. The calculation of dividing the signal by cos(ψ₁) corresponds to an adjustment of canceling out the amplitude variation reflecting the phase delay amount difference ψ₁. Thus, the error factor expressed by Formula (8) described above can be canceled out or reduced. As a result, the demodulation accuracy and the accuracy of the phase X can further be improved compared to the second embodiment.

Further, by adding the calculation described above, it is possible to reduce the design load of the high-pass filter 522.

In such a modified example as described above, substantially the same advantages as those of the second embodiment can be obtained.

### 4. Third Embodiment

Then, a laser interferometer 1 according to a third embodiment will be described.

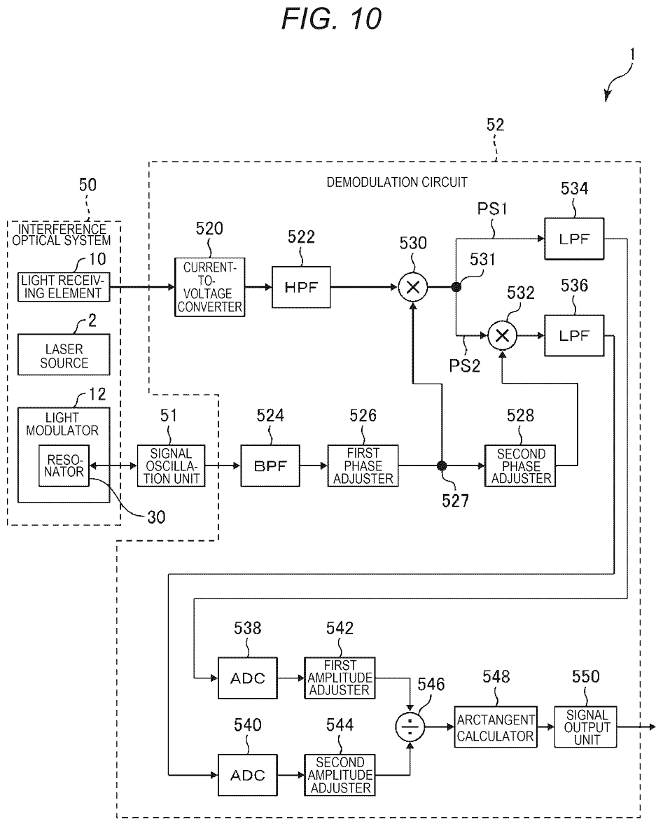

FIG. 10 is a functional block diagram showing the laser interferometer 1 according to the third embodiment.

The third embodiment will hereinafter be described, and in the following description, differences from the embodiments described above will be focused on, and description of substantially the same matters will be omitted.

The third embodiment is substantially the same as the first embodiment except that the configuration of the demodulation circuit 52 is different. Specifically, in the third embodiment, a second phase adjuster 528 is added to the demodulation circuit 52.

The second phase adjuster 528 illustrated in FIG. 10 is disposed between the branch point 527 and the second multiplier 532. That is, the second phase adjuster 528 further adjusts the phase of the reference signal the phase of which has been adjusted by the first phase adjuster 526.

Similarly to the first embodiment, the first phase adjuster 526 adjusts the phase of the reference signal so as to be in phase with the phase of the fundamental frequency component of the modulation signal contained in the laser light reception signal. In contrast, the second phase adjuster 528 adjusts the phase of one of the reference signals, which are output from the first phase adjuster 526 and are then branched at the branch point 527, so as to cancel out the phase delay amount difference ψ₁ in the high-pass filter 522. Thus, even when the phase delay amount difference ψ₁ is present in the high-pass filter 522, the influence thereof can be canceled out or reduced by the second multiplication in the second multiplier 532.

The effect described above will hereinafter be verified by calculation formulas.

The influence of the phase delay amount difference ψ₁ generated in the laser light reception signal I_{PD.AC} with the passage through the high-pass filter 522 is expressed by Formula (1e) described below.

$${I}_{PD , AC} = A [ \{ {J}_{0} ( B ) + 2 {J}_{2} ( B ) cos ( 2 {ω}_{M} t + {ψ}_{1} ) + 2 {J}_{4} ( B ) cos 4 {ω}_{M} t + ⋯ \} cos X - \{ 2 {J}_{1} ( B ) sin {ω}_{M} t + 2 {J}_{3} ( B ) sin 3 {ω}_{M} t + ⋯ \} sin X ] \qquad ( 1 e )$$

The first multiplier 530 multiplies the laser light reception signal I_{PD.AC} output from the high-pass filter 522 by the reference signal I_{S1} output from the first phase adjuster 526. In this way, a first multiplication signal is obtained. The first multiplication signal Iₕₑₜ₁ is expressed by Formula (11) described below.

$${I}_{het 1} = {AV}_{q} [ \{ 1 - cos ( 2 {ω}_{M} t + {ψ}_{1} ) \} / {J}_{1} ( B ) sin X + \{ sin ( 3 {ω}_{M} t + {ψ}_{1} ) + sin ( {ω}_{M} t + {ψ}_{1} ) \} {J}_{2} ( B ) cos X + ⋯ ] \qquad ( 11 )$$

Subsequently, when the removal of the harmonic components in the low-pass filter 534 is performed, only the DC term is output. Further, the amplitude is adjusted by the first amplitude adjuster 542. As a result, the first multiplication signal Iₕₑₜ₁ output from the first amplitude adjuster 542 is expressed by Formula (12) described below.

$${I}_{het 1} = {AJ}_{1} ( B ) {J}_{2} ( B ) {V}_{q}^{2} sin X \qquad ( 12 )$$

Meanwhile, as a result of the phase being adjusted by the second phase adjuster 528, the reference signal I_{S2} output from the second phase adjuster 528 is expressed by Formula (13) described below.

$${I}_{S 2} = {V}_{q} sin ( {ω}_{M} t + {ψ}_{1} ) \qquad ( 13 )$$

The second multiplier 532 multiplies the first multiplication signal Iₕₑₜ₁ divided to the second calculation path PS2 by the reference signal I_{S2} output from the second phase adjuster 528. Thus, the second multiplication signal Iₕₑₜ₂ is obtained. The second multiplication signal Iₕₑₜ₂ is expressed by Formula (14) described below.

$${I}_{het 2} = A {V}_{q}^{2} [ \frac{1}{2} \{ cos 2 ( {ω}_{M} t + {ψ}_{1} ) - 1 \} cos X + ⋯ ] \qquad ( 14 )$$

Subsequently, when the removal of the harmonic components in the low-pass filter 536 is performed, only the DC term is output. Further, the amplitude is adjusted by the second amplitude adjuster 544. As a result, the second multiplication signal Iₕₑₜ₂ output from the second amplitude adjuster 544 is expressed by Formula (15) described below.

$${I}_{het 2} = {AJ}_{1} ( B ) {J}_{2} ( B ) {V}_{q}^{2} cos X \qquad ( 15 )$$

As described above, the influence of the phase delay amount difference ψ₁ is eliminated in both of Formula (12) described above and Formula (15) described above. Therefore, by providing the second phase adjuster 528, the influence of the phase characteristic in the high-pass filter 522 can be suppressed. As a result, the demodulation accuracy and the accuracy of the phase X can further be improved. Further, the design load of the high-pass filter 522 can be reduced.

Here, the phase adjustment amount in the second phase adjuster 528 is defined as ψ₂. The phase adjustment amount ψ₂ is ideally made equal to the phase delay amount difference ψ₁ in the high-pass filter 522, but may bring a setting error in some cases. Therefore, the influence of the setting error δ (=|ψ₂−ψ₁|) will be considered.

The influence of the setting error δ is the same as the influence of the phase delay amount difference ψ₁ in the second embodiment.

Specifically, by suppressing the setting error δ to 10 [deg] or less, the measurement accuracy of the displacement can be suppressed to 1 nm or less. Thus, sufficient measurement accuracy is obtained.

Further, by suppressing the setting error δ to a value equal to 1 [deg] or less, the measurement accuracy of the displacement can be suppressed within 100÷0.01%. Thus, sufficient measurement accuracy is obtained.

In such a third embodiment as described above, substantially the same advantages as those of the first embodiment can be obtained.

### 5. Fourth Embodiment

Then, a laser interferometer 1 according to a fourth embodiment will be described.

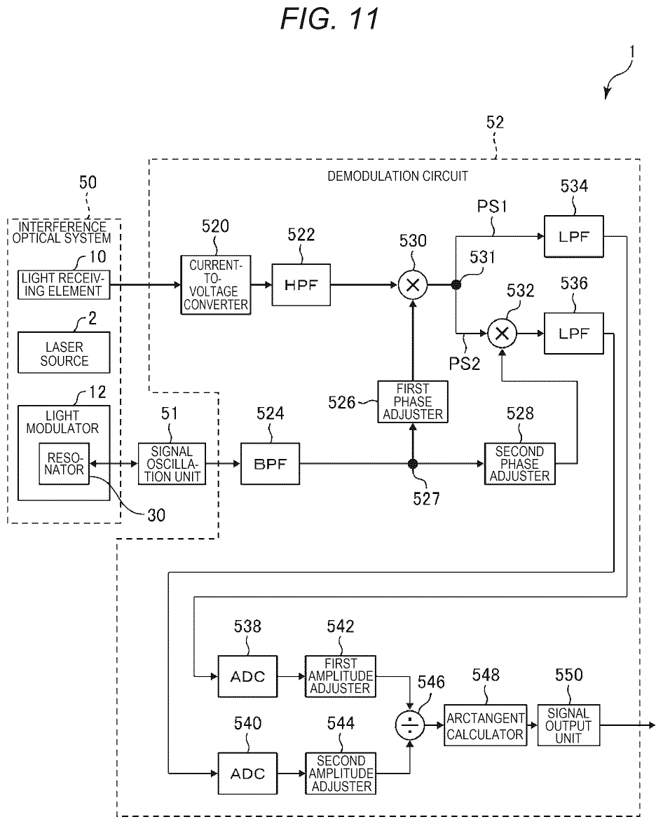

FIG. 11 is a functional block diagram showing the laser interferometer 1 according to the fourth embodiment.

The fourth embodiment will hereinafter be described, and in the following description, differences from the embodiments described above will be focused on, and description of substantially the same matters will be omitted.

The fourth embodiment is substantially the same as the third embodiment except that the configuration of the demodulation circuit 52 is different.

In the third embodiment described above, the first phase adjuster 526 is disposed between the band-pass filter 524 and the branch point 527, and the second phase adjuster 528 is disposed between the branch point 527 and the second multiplier 532.

In contrast, in the fourth embodiment, the first phase adjuster 526 is disposed between the branch point 527 and the first multiplier 530. Further, accordingly, the phase adjustment amount ψ₂ in the second phase adjuster 528 is changed.

Therefore, the fourth embodiment is substantially the same as the third embodiment except that the arrangement and setting of the first phase adjuster 526 are different.

Similarly to the first embodiment, the first phase adjuster 526 adjusts the phase of the reference signal so as to be in phase with the phase of the fundamental frequency component of the modulation signal contained in the laser light reception signal.

Meanwhile, the second phase adjuster 528 adjusts the phase of one of the reference signals, which are output from the band-pass filter 524 and are branched at the branch point 527, so as to be in phase with the phase of the fundamental frequency component of the modulation signal contained in the laser light reception signal, and also adjusts the phase of that reference signal so as to cancel out the phase delay amount difference ψ₁ in the high-pass filter 522. Accordingly, substantially the same advantages as those of the third embodiment are exerted.

The advantages described above will hereinafter be verified.

The phase adjustment amount when the first phase adjuster 526 adjusts the phase of the reference signal so as to be in phase with the phase of the fundamental frequency component of the modulation signal contained in the laser light reception signal is defined as ψ₀.

The second phase adjuster 528 adjusts the phase of one of the reference signals branched at the branch point 527 so as to be in phase with the phase of the fundamental frequency component of the modulation signal contained in the laser light reception signal. Therefore, the phase adjustment amount ψ₂ in the second phase adjuster 528 is set so as to satisfy ψ₂=ψ₀.

Further, in the present embodiment, an adjustment amount for canceling out the phase delay amount difference ψ₁ in the high-pass filter 522 is also added to the phase adjustment amount ψ₂ in the second phase adjuster 528. Therefore, the phase adjustment amount ψ₂ in the second phase adjuster 528 is set so as to satisfy ψ₂=ψ₀+ψ₁.

Also in such a fourth embodiment, the measurement accuracy of the displacement can be suppressed to 1 nm or less by suppressing the setting error δ (=|ψ₂−ψ₁|) of the phase adjustment amount ψ₂ to 10 [deg] or less. Thus, sufficient measurement accuracy is obtained.

Further, by suppressing the setting error & to a value equal to 1 [deg] or less, the measurement accuracy of the displacement can be suppressed within 100±0.01%. Thus, sufficient measurement accuracy is obtained.

In such a fourth embodiment as described above, substantially the same advantages as those of the first embodiment can be obtained.

### 6. Fifth Embodiment

Then, a spectroscopic apparatus according to a fifth embodiment will be described.

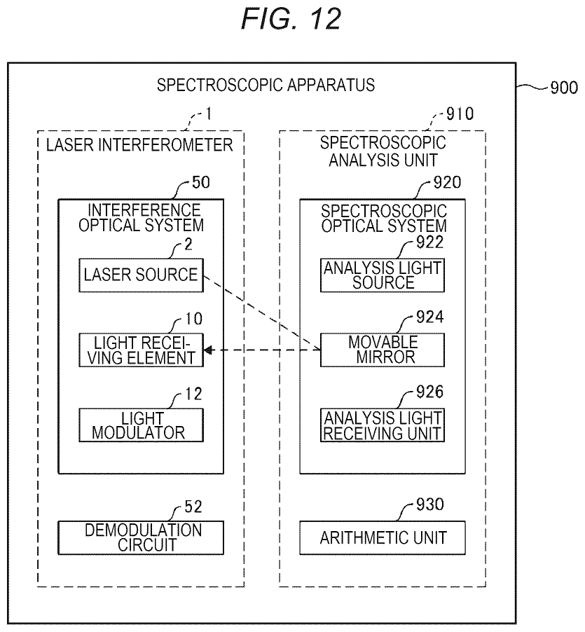

FIG. 12 is a functional block diagram showing a spectroscopic apparatus 900 according to the fifth embodiment.

The fifth embodiment will hereinafter be described, and in the following description, differences from the first embodiment will be focused on, and the descriptions of substantially the same matters will be omitted. Note that in FIG. 12, the same reference numerals are given to substantially the same configurations as those in FIG. 1.

The spectroscopic apparatus 900 shown in FIG. 12 includes the laser interferometer 1 according to each of the embodiments described above and a spectroscopic analyzer 910.

The spectroscopic analyzer 910 receives analysis light including a sample-derived signal generated through an interaction with the sample to generate spectrum information derived from the sample. The spectroscopic analyzer 910 shown in FIG. 12 includes a spectroscopic optical system 920 and an arithmetic unit 930. The spectroscopic optical system 920 includes an analysis light source 922, a movable mirror 924, and an analysis light receiving unit 926. In the spectroscopic optical system 920, the sample is irradiated with the analysis light emitted from the analysis light source 922, and then the analysis light is incident on an analysis light interferometer. The analysis light interferometer causes interference between the analysis light incident via the sample and the analysis light incident via the movable mirror 924 while moving the movable mirror 924 to change the light path length. Then, the interfering light is received by the analysis light receiving unit 926 to obtain an analysis light reception signal.

Meanwhile, the laser interferometer 1 measures the displacement of the movable mirror 924 to output a mirror position signal. Since the laser interferometer 1 can accurately measure the displacement of the movable mirror 924, the mirror position signal high in accuracy can be generated.

The arithmetic unit 930 generates a waveform (interferogram) representing an intensity of the interfering light with respect to the light path length in the spectroscopic optical system 920 based on the analysis light reception signal and the mirror position signal, and then performs Fourier transform on the waveform to generate the spectrum information.

Therefore, the spectroscopic analyzer 910 can generate highly accurate spectrum information based on the measurement result of the displacement of the movable mirror 924 by the laser interferometer 1.

Further, the laser interferometer 1 is easily reduced in cost as described above. Therefore, according to such a configuration as described above, it is possible to realize the spectroscopic apparatus 900 that is easily reduced in cost and is excellent in wavenumber resolution.

Note that by appropriately changing the type of the analysis light or the like, the spectroscopic apparatus 900 can be applied to Fourier-transform infrared spectroscopy (FT-IR), Fourier-transform near-infrared spectroscopy (FT-NIR), Fourier-transform visible spectroscopy (FT-VIS), Fourier-transform ultraviolet spectroscopy (FT-UV), Fourier-transform terahertz spectroscopy (FT-THz), and so on.

Further, the spectroscopic apparatus 900 can be applied to, for example, a white-light interferometric shape measurement apparatus or an optical coherence tomography (OCT) imaging apparatus by using an element that can acquire a two-dimensional light intensity distribution as the analysis light receiving unit 926.

### 7. Advantages Provided by Embodiments Described Above

The laser interferometer 1 according to each of the embodiments is a laser interferometer that irradiates the object 14 with the second split light L1b (laser light), and then receives the object light L3 (laser light) incident via the object 14 to acquire the displacement of the object 14, and includes the laser source 2, the light modulator 12, the photodetector 10, the oscillator 51, and the demodulation circuit 52. The laser source 2 emits the light L1 (laser light). The light modulator 12 includes the resonator 30, and adds the modulation signal to the first split light L1a (laser light) using the resonator 30. The photodetector 10 detects the intensity variation of the reference light L2 and the object light L3 (laser light) including the sample signal added by the object 14 and the modulation signal described above, and then outputs the laser light reception signal. The oscillator 51 generates the reference signal with the first frequency using the resonator 30 as the vibratory source. The demodulation circuit 52 demodulates the sample signal from the laser light reception signal based on the reference signal to acquire the displacement of the object 14.

The demodulation circuit 52 includes the high-pass filter 522 (the DC offset removal unit), the first phase adjuster 526, the first multiplier 530, the low-pass filter 534 (the first filter), the second multiplier 532, the low-pass filter 536 (the second filter), and the arctangent calculator 548 (the phase calculator).

The high-pass filter 522 removes the offset of the DC component of the laser light reception signal. The first phase adjuster 526 adjusts the phase of the reference signal. The first multiplier 530 multiplies the laser light reception signal output from the high-pass filter 522 by the reference signal output from the first phase adjuster 526, and outputs a first multiplication signal. The low-pass filter 534 removes the high-frequency component contained in the first multiplication signal. The second multiplier 532 multiplies the first multiplication signal by the reference signal output from the first phase adjuster 526, and outputs the second multiplication signal. The low-pass filter 536 removes the high-frequency component contained in the second multiplication signal. The arctangent calculator 548 calculates the phase derived from the object 14 as the sample signal based on the signal output from the low-pass filter 534 and the signal output from the low-pass filter 536.

According to such a configuration, the first multiplication signal and the second multiplication signal are reduced in frequency by performing the multiplication twice in the demodulation circuit 52. That is, the frequency of the signal provided to the arithmetic processing can be reduced. In this way, the coping frequency of the FPGA or the like in which some of the A/D converters 538, 540 and the demodulation circuit 52 are installed can be lowered, and the cost reduction can be achieved.

In the laser interferometer 1 according to each of the embodiments described above, the demodulation circuit 52 includes a band-pass filter 524 (a third filter). The band-pass filter 524 is disposed between the oscillator 51 and the first phase adjuster 526, and extracts the first frequency component contained in the reference signal.

According to such a configuration, the reference signal from which unnecessary frequency components (noise components) are removed is obtained.

In the laser interferometer 1 according to each of the embodiments described above, the demodulation circuit 52 includes the first amplitude adjuster 542 and the second amplitude adjuster 544 (the amplifier). The first amplitude adjuster 542 and the second amplitude adjuster 544 uniform the amplitude of the first multiplication signal output from the low-pass filter 534 (the first filter) and the amplitude of the second multiplication signal output from the low-pass filter 536 (the second filter).

According to such a configuration, the first multiplication signal and the second multiplication signal whose amplitudes are made uniform are obtained. This can improve the demodulation accuracy of the phase X.

In the laser interferometer 1 according to each of the embodiments described above, when defining the difference between the phase delay amount Φ₁ when the component with the frequency of the modulation signal passes and the phase delay amount Φ₂ when the component with the frequency twice as high as the frequency of the modulation signal passes as ψ₁, the high-pass filter 522 (the DC offset remover) is set so as to satisfy ψ₁≤10 [deg].

According to such a configuration, the demodulation accuracy and the accuracy of the phase X can be improved. This can improve the measurement accuracy of the displacement of the object 14 and the accuracy of the displacement measured.

In the laser interferometer 1 according to each of the embodiments described above, the high-pass filter 522 (the DC offset remover) is set so that the phase delay amount difference ψ₁ satisfies ψ₁≤1 [deg].

According to such a configuration, the demodulation accuracy and the accuracy of the phase X can be improved. This can improve the measurement accuracy of the displacement of the object 14 and the accuracy of the displacement measured.

In the laser interferometer 1 according to each of the embodiments described above, the demodulation circuit 52 includes the first amplitude adjuster 542 and the second amplitude adjuster 544 (the amplifier). The first amplitude adjuster 542 and the second amplitude adjuster 544 adjust at least one of the amplitude of the first multiplication signal output from the low-pass filter 534 (the first filter) and the amplitude of the second multiplication signal output from the low-pass filter 536 (the second filter). Further, the first amplitude adjuster 542 and the second amplitude adjuster 544 have a function of adjusting the amplitude of the first multiplication signal and the amplitude of the second multiplication signal so as to be uniformed, and a function of adjusting the amplitude of the second multiplication signal so as to cancel out the amplitude variation reflecting the phase delay amount difference Φ₁.

According to such a configuration, it is possible to cancel out or reduce the error factors that degrade the demodulation accuracy of the phase X. As a result, the demodulation accuracy and the accuracy of the phase X can further be improved.

In the laser interferometer 1 according to each of the embodiments described above, the first phase adjuster 526 adjusts the phase of the reference signal so as to be in phase with the fundamental frequency component of the modulation signal contained in the laser light reception signal.

According to such a configuration, the phase of the fundamental frequency component of the modulation signal contained in the laser light reception signal and the phase of the reference signal can be made uniform. Thus, it is possible to suppress a degradation of the demodulation accuracy and the accuracy of the phase X.

In the laser interferometer 1 according to each of the embodiments described above, the demodulation circuit 52 includes the second phase adjuster 528. The second phase adjuster 528 is disposed between the oscillator 51 and the second multiplier 532, and adjusts the phase of the reference signal so that the phase of the reference signal is in phase with the phase of the fundamental frequency component of the modulation signal contained in the laser light reception signal, and the phase adjustment amount ψ₂ which is the same as the phase delay amount difference ψ₁ in the pass band of the high-pass filter 522 (the DC offset remover) is generated in the first frequency component from the phase which is in phase with the phase of the fundamental frequency component of that modulation signal.

According to such a configuration, the influence of the phase delay amount difference ψ₁ in the high-pass filter 522 can be canceled out or reduced by the multiplication by the second multiplier 532. Further, the design load of the high-pass filter 522 can be reduced.

In the laser interferometer 1 according to each of the embodiments described above, the demodulation circuit 52 is disposed between the first phase adjuster 526 and the second multiplier 532, and adjusts the phase of the reference signal so that the phase adjustment amount ψ₂ which is the same as the phase delay amount difference ψ₁ in the pass band of the high-pass filter 522 (the DC offset remover) is generated in the first frequency component from the phase of the reference signal output from the first phase adjuster 526.

According to such a configuration, the influence of the phase delay amount difference ψ₁ in the high-pass filter 522 can be canceled out or reduced by the multiplication by the second multiplier 532. Further, the design load of the high-pass filter 522 can be reduced.

Further, the spectroscopic apparatus 900 according to the embodiment described above includes the laser interferometer 1 according to each of the embodiments described above and the spectroscopic analyzer 910. The spectroscopic analyzer 910 includes the spectroscopic optical system 920 including the movable mirror 924, and generates the spectrum information derived from the sample. The laser interferometer 1 measures the displacement of the movable mirror 924. Then, the spectroscopic analyzer 910 generates the spectrum information based on the measurement result of the displacement of the movable mirror 924 measured by the laser interferometer 1.

According to such a configuration, the reduction in cost of the spectroscopic apparatus 900 can easily be achieved.

Although the laser interferometer and the spectroscopic apparatus according to the present disclosure are described hereinabove based on the illustrated embodiments, the laser interferometer and the spectroscopic apparatus of the present disclosure are not limited to each of the embodiments described above, and the configuration of each unit may be replaced with any other constituents, or any other constituents may be added thereto.

Further, although a Michelson interference optical system is used in each of the embodiments described above, other types of interference optical systems may be used.

What is claimed is:

1. A laser interferometer comprising:
a laser source configured to emit a;
a light modulator which includes a resonator and is configured to add a modulation signal to the laser light using the resonator;
a photodetector configured to detect a change in intensity of the laser light including a sample signal added by an object and the modulation signal to output a laser light reception signal;
a oscillator configured to generate a reference signal with a first frequency using the resonator as a vibratory source; and
a demodulation circuit configured to demodulate the sample signal from the laser light reception signal based on the reference signal to obtain the displacement of the object, wherein
the demodulation circuit includes
a DC offset remover configured to remove an offset of a direct current component of the laser light reception signal,
a first phase adjuster configured to adjust a phase of the reference signal,
a first multiplier configured to multiply the laser light reception signal output from the DC offset remover by the reference signal output from the first phase adjuster to output a first multiplication signal,
a first filter configured to remove a high-frequency component contained in the first multiplication signal,
a second multiplier configured to multiply the first multiplication signal and the reference signal output from the first phase adjuster to output a second multiplication signal,
a second filter configured to remove a high-frequency component contained in the second multiplication signal, and
a phase calculator configured to calculate a phase derived from the object as the sample signal based on a signal output from the first filter and a signal output from the second filter.

2. The laser interferometer according to claim 1, wherein
the demodulation circuit includes
a third filter which is disposed between the oscillator and the first phase adjuster and is configured to extract a component with the first frequency contained in the reference signal.

3. The laser interferometer according to claim 1, wherein
the demodulation circuit includes
an amplifier configured to uniform an amplitude of the first multiplication signal output from the first filter and an amplitude of the second multiplication signal output from the second filter.

4. The laser interferometer according to claim 1, wherein
the DC offset remover is set so as to satisfy ψ₁≤10 [deg] when defining a difference between a phase delay amount when a component with a frequency of the modulation signal passes and a phase delay amount when a component with a frequency twice as high as the frequency of the modulation signal passes as ψ₁.

5. The laser interferometer according to claim 4, wherein
the DC offset remover is set so that the phase delay amount difference ψ₁ satisfies ψ₁≤1 [deg].

6. The laser interferometer according to claim 4, wherein
the demodulation circuit includes
an amplifier configured to adjust at least one of the amplitude of the first multiplication signal output from the first filter and the amplitude of the second multiplication signal output from the second filter, wherein
the amplifier adjusts the amplitude of the first multiplication signal and the amplitude of the second multiplication signal so as to be made uniform, and adjusts the amplitude of the second multiplication signal so as to cancel out an amplitude variation reflecting the phase delay amount difference ψ₁.

7. The laser interferometer according to claim 1, wherein
the first phase adjuster is configured to adjust the phase of the reference signal so as to be in phase with a fundamental frequency component of the modulation signal contained in the laser light reception signal.

8. The laser interferometer according to claim 7, wherein
the demodulation circuit includes
a second phase adjuster which is disposed between the oscillator and the second multiplier, and is configured to adjust the phase of the reference signal so that the phase of the reference signal is in phase with a phase of the modulation signal contained in the laser light reception signal, and a phase adjustment amount equal to a phase delay amount difference in a pass band of the DC offset remover is generated in a component with the first frequency from the phase in phase with the phase of the modulation signal.

9. The laser interferometer according to claim 7, wherein
the demodulation circuit is disposed between the first phase adjuster and the second multiplier, and is configured to adjust the phase of the reference signal so that a phase adjustment amount equal to a phase delay amount difference in a pass band of the DC offset remover is generated in a component with the first frequency from a phase of the reference signal output from the first phase adjuster.

10. A spectroscopic apparatus comprising:
the laser interferometer according to claim 1; and
a spectroscopic analyzer which includes a spectroscopic optical system including a movable mirror and is configured to generate spectrum information derived from a sample, wherein
the laser interferometer measures a displacement of the movable mirror, and
the spectroscopic analyzer generates the spectrum information based on a measurement result of the displacement of the movable mirror by the laser interferometer.
